(19) United States
(12) Patent Application Publication
(10) Pub. No.: US 2005/0167488 A1
(43) Pub. Date: Aug. 4, 2005

(54) Gaming system using an automated teller machine

(76) Inventors: John B. Higgins, Bethany, OK (US); Michael J. Davis, Wichita, KS (US); Robert L. Montgomery, Indianapolis, ID (US); Allan B. Zukermann, Indaianapolis, ID (US)

Correspondence Address: DUNLAP, CODDING & ROGERS P.C., PO BOX 16370, OKLAHOMA CITY, OK, 73113, US

(21) Appl. No.: 10/493,512

(22) PCT Filed: Nov. 6, 2002
(86) PCT No.: PCT/US02/35776

Related U.S. Application Data
(60) Provisional application No. 60/333,275, filed on Nov. 6, 2001.

(51) Int. Cl. G06F 7/08

(52) U.S. Cl. 235/381

(57) ABSTRACT

Disclosed in this writing is an automated teller machine. The machine includes mechanisms for conducting a financial transaction as well as for providing game cards, prizes, prize money, game-card redemption receipts, and placing bets or wages as a form of internet gambling in association with the financial transaction.

### CROSS-REFERENCE TO RELATED APPLICATIONS

This application claims priority to the provisional patent application identified by U.S. Ser. No. 60/333,275, filed on Nov. 6, 2001, the entire disclosure of which is hereby incorporated herein by reference for all purposes.

### STATEMENT REGARDING FEDERALLY SPONSORED RESEARCH AND DEVELOPMENT

Not Applicable.

### BACKGROUND OF THE INVENTION

The automated teller machine (ATM) has been in use for a number of years as a convenient way to dispense money to persons instantly from credit cards, banking accounts, or any other account in which the person is able to withdraw money or utilize a form of credit. These machines charge a user fee and are located in grocery stores, convenience stores, and certain other business establishments in which persons may need to quickly and conveniently obtain money. After inserting a designated transaction card into the automated teller machine, the user is given the option of withdrawing money from his checking account, savings account, or credit line, transferring money between accounts, or inquiring as to a banking account balance. The user may perform any or all of these options during one transaction. Upon completion of a transaction, a receipt is printed for the user to view his transaction.

Various types of games exist where game cards are used as a part of the game. Common examples of these types of games include bingo and keno.

However, to Applicant's knowledge, the automated teller machine has not been used to dispense prizes, prize money, game cards, game-card redemption receipts, and placing bets or wages as a form of internet gambling. It is to such a gaming system using the automated teller machine that the present invention is directed.

### SUMMARY OF THE INVENTION

The present invention relates to a method and apparatus for a gaming system, and more particularly for a gaming system that is utilized by the player through the use of an automated teller machine as a vehicle for dispensing prizes, prize money, game cards, game-card redemption receipts, and placing bets or wages as a form of internet gambling. In one preferred embodiment, the gaming system includes a broadcast network, a gaming machine, and a receiver unit. The broadcast network outputs broadcast signals indicative of a game, such as bingo or keno. The broadcast signals can be radio, television or internet broadcast signals. The gaming machine is preferably an automated teller machine. The automated teller machine is provided at a location separate from the broadcast network. For example, the automated teller machine can be provided at retail locations, such as grocery or convenience stores. The automated teller machine provides a game card to a user. The game card can be for bingo, keno or the like. The automated teller machine can dispense a pre-printed game card, print a game card, or provide a voucher so that the user can present the voucher to a clerk and receive one or more game cards. The receiver unit, such as a radio or television, receives the broadcast signals indicative of the game and outputs such broadcast signals in a format perceivable by the user.

The purpose of this invention is to unite the automated teller machine industry with the entertainment industry. This invention may be particularly useful in the truck-driving profession. Truck drivers often operate a vehicle for an extended period of time and by tuning into a radio broadcast, the driver can play trivia or the like in order to increase his level of mental alertness. The driver can communicate answers to a prize coordinator with an input device, such as a cellular telephone, personal data assistant, the internet or the like.

Other examples of the present invention will become apparent to one skilled in the art when the following detailed description is read in conjunction with the attached drawings and appended claims.

### BRIEF DESCRIPTION OF THE SEVERAL VIEWS OF THE DRAWING

FIG. 1 is a schematic, diagrammatic view of a gaming system constructed in accordance with the present invention.

FIG. 2 is a top plan view of a game card provided by an automated teller machine in accordance with the present invention.

### DETAILED DESCRIPTION OF THE INVENTION

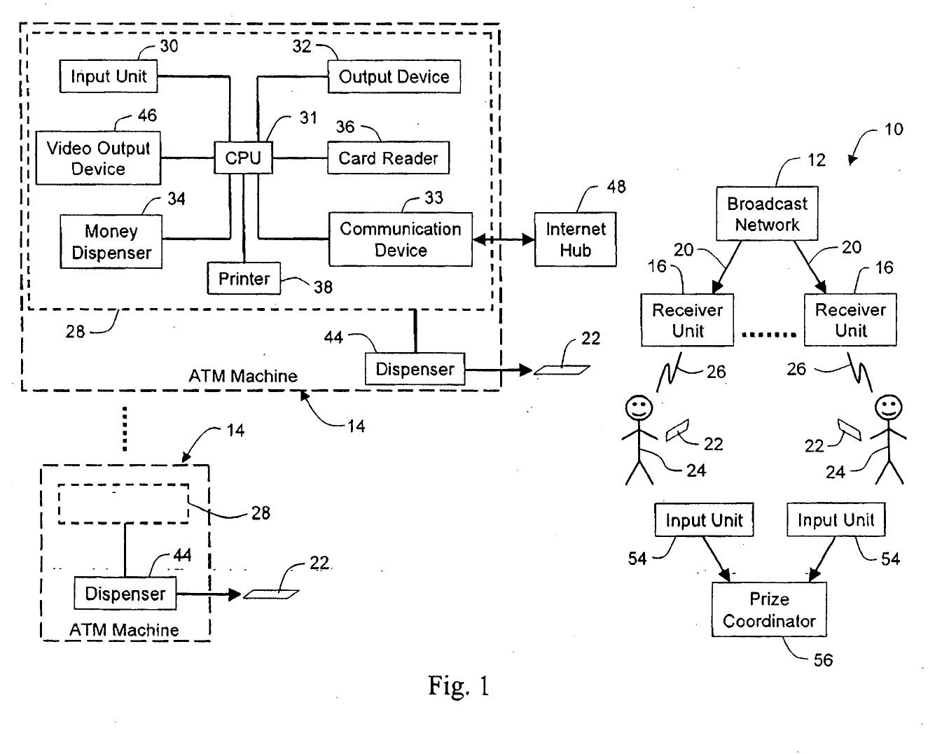

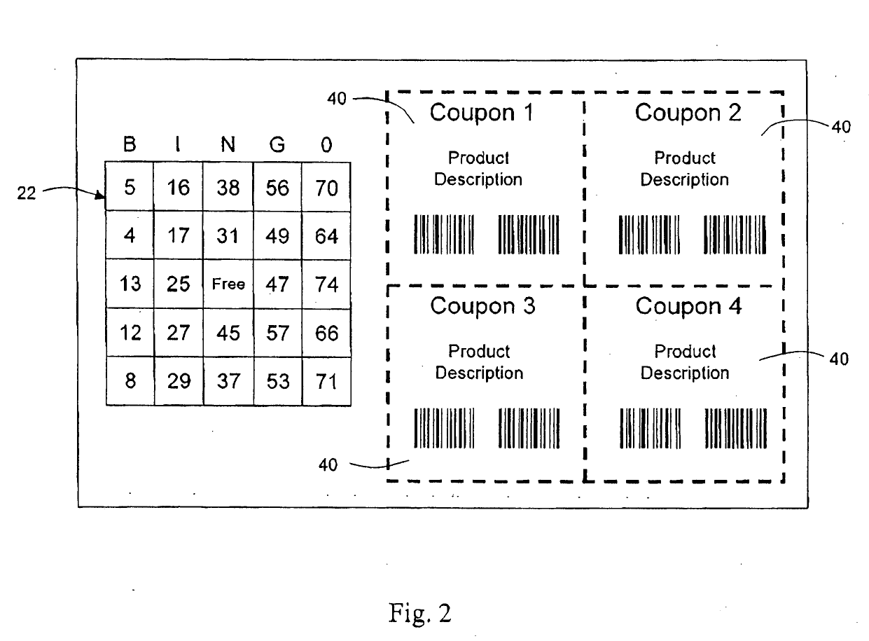

Referring now to the drawings, and in particular to FIG. 1, shown therein and designated by a reference numeral 10 is a gaming system constructed in accordance with the present invention. The gaming system 10 is provided with a broadcast network 12, one or more gaming machines 14, and one or more receiver unit 16. Only two of the gaming machines 14 and receiver units 16 are shown in FIG. 1 for purposes of clarity. The broadcast network 12 outputs broadcast signals 20 indicative of a game, such as bingo, keno, trivia or the like. The broadcast signals 20 can be radio, television or internet broadcast signals. The gaming machine 14 is provided at a location separate or remote from the broadcast network 12. For example, the gaming machine 14 can be provided at retail locations, such as grocery or convenience stores. The gaming machine 14 provides a game card 22 (FIG. 2) to a user 24. The game card 22 can be for bingo, keno, trivia or the like. The gaming machine 14 can store and selectively dispense a pre-printed game card directly to the user 24, print a game card, or provide a voucher so that the user 24 can present the voucher to a clerk and receive one or more game cards. The receiver unit 16, such as a radio, television or computer, receives the broadcast signals 20 indicative of the game and outputs such broadcast signals in a format perceivable by the user 24, as indicated by the signal path 26.

The term “broadcast” as used herein refers to a signal being output on a large-scale such that the signal can be received by a large number of receiver units 16. Common examples of the broadcast network 12 are radio or television stations in which the receiver unit 16 is tuned to a particular channel or channels to receive the broadcast signal. The broadcast network 12 can be local, national, or satellite television, radio or internet broadcasts. The broadcast network 12 can be a web-site or other entity in communication with the internet for outputting signals over the internet.

The terms “user” or “player” are used interchangeably herein.

In one preferred embodiment, the gaming machine 14 includes an automated teller machine 28. The automated teller machine 28 is provided with an input unit 30, a CPU 31, a video or audio output device 32, a communication device 33, a money dispenser 34, a transaction card reader 36 and a printer 38. The input unit 30 is commonly a keyboard or a touch-screen video, and the transaction card reader 36 is commonly a magnetic card reader, or a bar-code reader. The input unit 30 and the transaction card reader 36 can be implemented in other forms.

In a particular example of the invention, the gaming machine 14 can be used for such games as bingo, keno or the like in which the player 24 inserts a transaction card such as for example and without limitation, VISA, MasterCard, or American Express, and bank account access cards, or any other transaction card into a designated automated teller machine 28, e.g., feeding the card into the transaction card reader 36. The player 24 is given the option of withdrawing money from his checking account, savings account, or credit line, transferring money between accounts, or inquiring as to a banking account balance by utilizing the input unit 30 and the video or audio output device 32. The player 24 may perform any or all of these options during one transaction. Upon completion of the transaction, a receipt for the transaction will be printed which includes a redemption receipt for the game card 22. An ATM surcharge is typically applied to each machine transaction, but there may or may not be an additional fee for the game card 22. After displaying the redemption receipt to a store clerk, the player 24 will receive a number of game cards 22, e.g., one to three, with or without attached coupons 40 (see FIG. 2). The attached coupons 40 may be redeemed towards additional bingo cards, keno cards, lottery cards, goods or services, or the like.

In another embodiment of the gaming machine 14, the printer 38 is utilized to print a voucher separate from or the same as the transaction receipt for the player 24 to obtain a designated game card 22 from the store clerk.

In yet another embodiment, the gaming machine 14 can print the game card 22 directly from the gaming machine 14 through the use of the printer 38, a separate printer, a dispenser, or the like in order for the player 24 to directly obtain the game card(s) 22 without involving a separate receipt, voucher, or store clerk. For example, the gaming machine 14 can include a game card dispenser 44 for distributing pre-printed game cards 22. The game card dispenser 44 can be any dispenser capable of distributing the pre-printed game cards 22. The particular game card dispenser 44 utilized may depend on the size of the pre-printed game cards. For example, a suitable dispenser for distributing the pre-printed game cards 22 has been found which is normally used for dispensing danish money. Dispensers are obtainable from Triton Systems of Long Beach, Miss.

The gaming machine 14 can also include a video output device 46 for outputting full motion video. The full motion video can be advertising information, or can allow the winner of the game and prizes to be viewed. In this embodiment, the gaming machine 14 can be connected to an internet hub 48, which is separate from the gaming machine 14. The video output device 46 can be a full motion video topper obtainable from Triton of Long Beach, Miss.

The gaming machine 14 can also be used to place bets and/or wagers. For example, the gaming machine 14 could be connected to the internet or other suitable communication network and allow the bets or wagers to be entered via the input unit 30 of the gaming machine 14. The bet or wager can be deducted from the account referenced by the user's transaction card.

After obtaining the game card 22, the player 24 may then tune into a broadcast from the broadcast network 12 in order to participate in various games and game shows. A winning game card 22 may be redeemed by the player 24 through the use of an input unit 54, such as mail, telephone, internet, or the like to claim the prize by contacting a prize coordinator 56. The prize coordinator 56 will verify the winning game card 22 and redeem the prize. For example, each game card 22 can be provided with a unique code so that each game card 22 can be identified and thus verified. The unique code can be provided on the game card 22 by any suitable manner, such as printing, bar code or magnetic stripe. The prize can be redeemed in any suitable fashion known in the art, such as check, cash or physical prizes. Alternatively, the prize can be redeemed by mailing or otherwise deliverying a transaction card (linked to an account containing the prize) to the player 24 to be used in an automated teller machine in order to redeem the prize money.

As a short review, disclosed in this writing is a method and apparatus for a gaming system, and more particularly for a gaming system that is utilized by the player through the use of an automated teller machine as a vehicle for dispensing prizes, prize money, game cards, game-card redemption receipts, and placing bets or wages as a form of internet gambling. In one preferred embodiment, the gaming system includes a broadcast network, a gaming machine, and a receiver unit. The broadcast network outputs broadcast signals indicative of a game, such as bingo or keno. The broadcast signals can be radio, television or internet broadcast signals. The gaming machine is preferably an automated teller machine. The automated teller machine is provided at a location separate from the broadcast network. For example, the automated teller machine can be provided at retail locations, such as grocery or convenience stores. The automated teller machine provides a game card to a user. The game card can be for bingo, keno or the like. The automated teller machine can dispense a pre-printed game card, print a game card, or provide a voucher so that the user can present the voucher to a clerk and receive one or more game cards. The receiver unit, such as a radio or television, receives the broadcast signals indicative of the game and outputs such broadcast signals in a format perceivable by the user.

While presently preferred embodiments of the present invention have been described herein, one skilled in the art will recognize that many changes or alterations can be made to the preferred embodiments without departing from the spirit and scope of the present invention. It is therefore intended that all such modifications, alterations and other changes be encompassed by the claims.

1. A gaming system, comprising:
a broadcast network outputting broadcast signals indicative of a game;
a gaming machine provided at a location separate from the broadcast network, the gaming machine providing a game card to a user; and
a receiver unit receiving the broadcast signals indicative of the game and outputting such broadcast signals in a format perceivable by the user.

2. The gaming system of claim 1, wherein the gaming machine provides the game card to the user without charging a fee for the game card.

3. The gaming system of claim 2, wherein the broadcast network is a television network.

4. The gaming system of claim 1, wherein the gaming machine includes an automated teller machine.

5. The gaming system of claim 4, wherein the automated teller machine provides pre-printed game cards to the user.

6. The gaming system of claim 4, wherein the automated teller machine provides a voucher to the user whereby the user presents the voucher to a clerk to receive the game card.

7. The gaming system of claim 4, wherein the automated teller machine prints the voucher.

8. A method, comprising the step of:
providing a game card by an automated teller machine.

9. The method of claim 8, wherein the step of providing the game card is defined further as printing a receipt having a redemption receipt for the game card whereby the user can receive one or more game cards upon displaying the redemption receipt to a store clerk.

10. The method of claim 8, wherein the method further comprises the step of printing a transaction receipt by the automated teller machine and wherein the step of providing the game card is defined further as printing a voucher separate from the transaction receipt.

11. The method of claim 8, wherein the step of providing the game card is defined further as dispensing a pre-printed game card from the automated teller machine.

12. The method of claim 8, wherein the game card includes at least one coupon.

13. The method of claim 8, wherein the game card includes attached coupons.

14. The method of claim 8, wherein prior to the step of providing the game card, the method comprises the steps of:
reading data by the automated teller machine from a transaction card associated with a user; and
conducting a transaction utilizing the data read from the transaction card.

15. The method of claim 14, wherein the step of providing the game card is defined further as printing a receipt having a redemption receipt for the game card whereby the user can receive one or more game cards upon displaying the redemption receipt to a store clerk.

16. The method of claim 14, wherein the method further comprises the step of printing a transaction receipt by the automated teller machine and wherein the step of providing the game card is defined further as printing a voucher separate from the transaction receipt.

17. The method of claim 14, wherein the step of providing the game card is defined further as dispensing a pre-printed game card from the automated teller machine.

18. The method of claim 14, wherein the game card includes at least one coupon.

19. The method of claim 14, wherein the game card includes attached coupons.

20. An automated teller machine, comprising:
means for conducting a financial transaction; and
means for providing a game card in association with the financial transaction.

21. The automated teller machine of claim 20, wherein the means for providing the game card includes means for printing a receipt having a redemption receipt for the game card whereby the user can receive one or more game cards upon displaying the redemption receipt to a store clerk.

22. The automated teller machine of claim 20, wherein the means for providing the game card includes means for printing a transaction receipt and means for printing a voucher separate from the transaction receipt.

23. The automated teller machine of claim 20, wherein the means for providing the game card is defined further as means for dispensing a pre-printed game card.

24. The automated teller machine of claim 20, wherein the game card includes at least one coupon.

25. The automated teller machine of claim 20, wherein the game card includes attached coupons.

26. The automated teller machine of claim 20, wherein the means for conducting the financial transaction includes means for reading data from a transaction card associated with a user.

27. The automated teller machine of claim 26, wherein the means for providing the game card is defined further as means for printing a receipt having a redemption receipt for the game card whereby the user can receive one or more game cards upon displaying the redemption receipt to a store clerk.

28. The automated teller machine of claim 26, further comprising means for printing a transaction receipt and wherein the means for providing the game card is defined further as means for printing a voucher separate from the transaction receipt.
